(19) United States
(12) Patent Application Publication
(10) Pub. No.: US 2009/0205248 A1
(43) Pub. Date: Aug. 20, 2009

(54) Frost Guard and Method of Use Thereof

(76) Inventor: Charles C. Phelps, Milledgeville, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/369,071

(22) Filed: Feb. 11, 2009

Related U.S. Application Data
(60) Provisional application No. 61/065,750, filed on Feb. 15, 2008.

(51) Int. Cl. A01G 13/00; A01G 13/02

(52) U.S. Cl. 47/2; 47/29.1

(57) ABSTRACT

A frost guard that is light weight, transparent and easily compacted facilitating storage and transport. The frost guard has an inverted U-shaped frame and a transparent, flexible plastic sheet over the frame, wherein the sheet protects plants under the frost guard from excessive wind and moisture, thereby preventing frost damage to the plants. The frame is placed over the plants to be protected, such that only slight air flow occurs through C-shaped apertures in the plastic sheet.

### CROSS-REFERENCE TO RELATED APPLICATIONS

The present application is a continuation application to provisional patent application Ser. No. 61/065,750, entitled “FROST GUARD”, filed on Feb. 15, 2008, and claims priority thereto and the full benefit thereof.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The preferred embodiment relates generally to apparatuses utilized to protect growing plants from frost, and more specifically to a protective envelope and method of use thereof that covers growing plants, while permitting air transit through the envelope.

2. Description of Related Art

Many people grow plants for food or for the aesthetic pleasure of their appearance. Many such plants are perennial in nature, and, thus, must survive a cold season. Generally, plants are able to stand the cold weather, but can be destroyed by frost caused by condensation and freezing of moisture in the air on the plant's surfaces, particularly leaf surfaces.

Typically, such plants are kept in a greenhouse that provides protection from adverse weather and which often has heating systems to keep the plants at a selected temperature. Unfortunately, such greenhouses are expensive to construct and providing heat utilizes expensive energy. In the absence of a greenhouse, a gardener must often bring plants inside during inclement weather that could produce a destructive frost. However, such requires keeping close track of the weather due to vagaries in same, and usually requires adopting a conservative approach to bringing plants indoors even when the weather might not affect them.

Another approach to preventing frost is to actually apply an excess of moisture that will not have time to freeze, but such is only suitable when the frost is not hard, i.e., severe.

Yet another approach requires utilizing individual containers inverted over the plants, such as foamed polystyrene containers, but such must typically be placed over individual plants, do not collapse for storage or transport, and are not transparent such that the plant owner can visually observe the plant's condition.

Therefore, it is readily apparent that there is a need for a frost guard and method of use thereof, wherein the frost guard easily and quickly assembled to protect plants during freezing cold weather.

### BRIEF SUMMARY OF THE INVENTION

Briefly described, a preferred embodiment overcomes the above-mentioned disadvantages and meets the recognized need for such an apparatus by providing a frost guard and method of use thereof, wherein the frost guard is light in weight, easily compacted and movable, and wherein the frost guard comprises an inverted U-shaped framework with a clear plastic sheet over the framework. The framework is placed over plants to be protected, such that only slight air flow occurs through C-shaped apertures in the plastic sheet. The frost guard is inserted into the ground surface surrounding the plants.

According to its major aspects and broadly stated, the preferred embodiment is a frost guard comprising a thin sheet of flexible material secured in contact with a plurality of U-shaped securing stakes. The thin sheet of flexible material is approximately 3 mils in thickness, is made from transparent plastic material and has a plurality of C-shaped ventilation apertures therein. The U-shaped securing stakes have a semicircular top section and two straight, approximately parallel, leg sections extending from the semicircular top section. At the other end of the straight sections they taper to a point to facilitate insertion into a ground surface. In its preferred embodiment, the frost guard is approximately ten feet long, two feet wide and three feet high.

The frost guard is utilized for protecting plants from frost, wherein a sheet of thin, flexible material is formed into a U-shape and secured over a plurality of U-shaped securing stakes. Subsequently, the arms of the U-shaped stakes are inserted into a ground surface covering plants disposed on the ground surface. The apertures provide air flow through the frost guard, thereby preventing mold and mildew.

More specifically, the preferred embodiment is a frost guard having U-shaped sections and a thin film sheet covering the U-shaped sections. The U-shaped sections preferably comprise rigid plastic material and have semicircular top portions and generally straight and parallel leg sections. The leg sections taper to form tips. The thin film sheet is flexible, transparent, and is approximately 3 mils in thickness.

The tapered tips facilitate insertion of the tips into a ground surface for installation of the frost guard. The thin film sheet has C-shaped apertures formed therethrough that provide access by air flow into the interior of the frost guard.

To utilize the frost guard, the thin film sheet is secured to the U-shaped sections by thermal bonding, but may be bonded to U-shaped sections by other bonding methods, such as, for exemplary purposes only, adhesive bonding. The frost guard can be collapsed such that the U-shaped sections are next to each other for storage, packaging and/or transportation purposes. When expanded, the thin film sheet is flat and the U-shaped sections are spaced approximately two-and-one-half feet apart, forming a generally semicircular inverted U-shaped tube that is ten feet long, two feet wide and three feet high.

To install the frost guard, it is disposed over selected plants and the tips of the U-shaped sections are inserted into the ground. The thin film sheet is disposed perpendicular to the prevailing wind direction to provide protection from severe cold wind, while also allowing air flow into the interior of the frost guard through the C-shaped apertures. This prevents mildew, mold and plant diseases caused by cold moist conditions. The “C” shape of the apertures permits some flow of air when the air is impacting on the thin film sheet, but the apertures close to form a uniform surface when the air is not so impacting. Moisture in the interior of the frost guard preferentially condenses on the thin film, keeping moisture off of the plants being protected, thereby preventing a buildup of frost that could destroy the plants.

Accordingly, a feature and advantage of the present invention is its ability to protect a plant from frost during cold seasonal weather.

Another feature and advantage of the present invention is its ability to permit airflow over the plant.

Still another feature and advantage of the present invention is its ability to permit observation of the plant by the transparent nature of the invention.

Yet another feature and advantage of the present invention is its ability to condense moisture on surfaces other than the plant surface, thereby protecting the plant from frost.

Yet still another feature and advantage of the present invention is that it is collapsible for easy storage.

A further feature and advantage of the present invention is that it is easy to install.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a side view of a frost guard according to a preferred embodiment;

FIG. 2 is an end view of the frost guard depicted in FIG. 1; and

FIG. 3 is a perspective view of a frost guard accordingly to the preferred embodiment, shown in use.

### DETAILED DESCRIPTION OF THE PREFERRED EMBODIMENT OF THE INVENTION

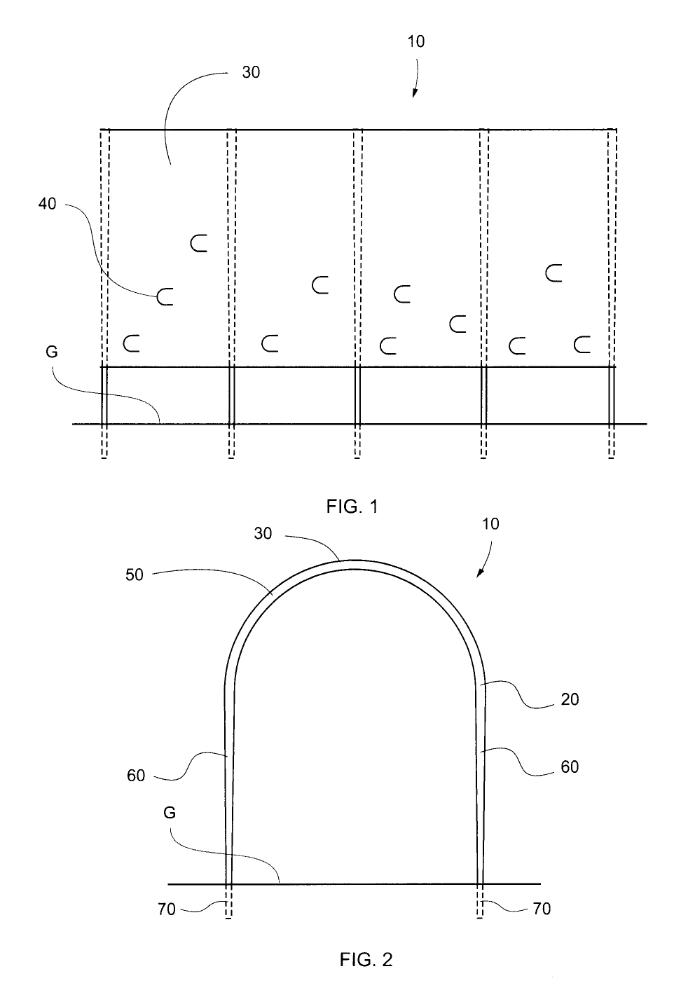

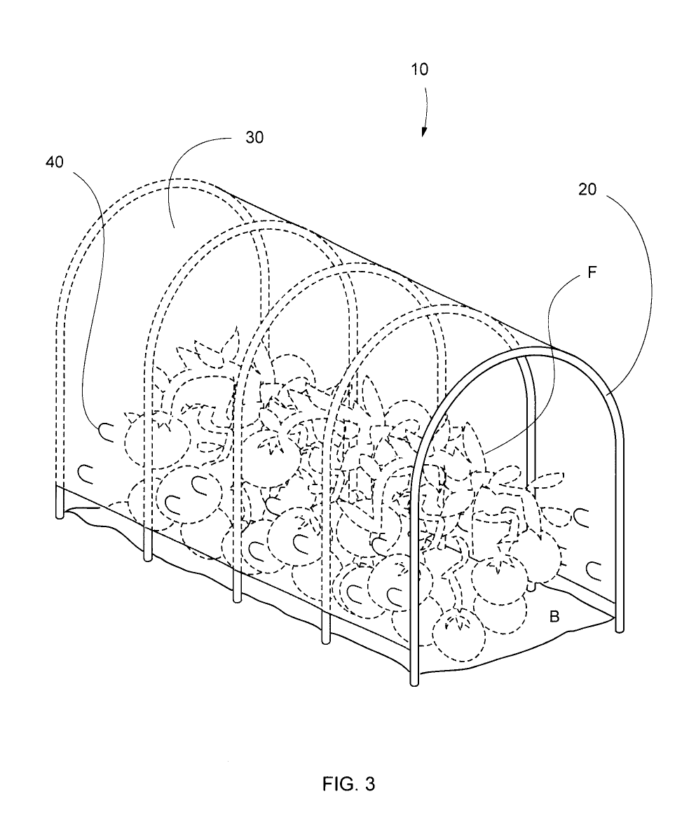

In describing the preferred embodiment of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is a frost guard and method of use thereof, wherein frost guard 10 preferably comprises U-shaped sections 20 and thin film sheet 30, wherein U-shaped sections 20 preferably comprise semicircular top portion 50 and generally straight leg sections 60, and wherein leg sections 60 preferably comprise tips 70, and wherein leg sections 60 are preferably generally parallel. U-shaped sections 20 preferably comprise rigid plastic material and thin film sheet 30 is preferably approximately 3 mils in thickness and is transparent.

U-shaped sections 20 preferably generally taper from semicircular top portion 50 to tips 70, wherein taper of tips 70 preferably facilitates insertion of tips 70 into ground surface G. Thin film sheet 30 preferably comprises C-shaped apertures 40 formed therethrough, wherein C-shaped apertures provide access by air flow into interior of frost guard 10.

In use, thin film sheet 30 is preferably secured to U-shaped sections 20 by thermal bonding. It will recognized by those skilled in the art that any method of securing thin film sheet 30 to U-shaped sections 20 could be utilized without departing from the spirit of the preferred embodiment, such as, without limitation, adhesive bonding. Because thin film sheet 30 is flexible, frost guard 10 can be collapsed, wherein U-shaped sections 20 are disposed proximate one another for storage, packaging and/or transportation purposes. When expanded such that thin film sheet 30 is flat, U-shaped sections 20 are spaced approximately two-and-one-half feet apart, and thin film sheet 30 and U-shaped sections 20 form a generally semicircular inverted U-shaped tube. Frost guard 10 when fully assembled and placed on a ground surface over plants F, is approximately ten feet long, two feet wide and three feet high.

Frost guard 10 is disposed over plants F in bed B, wherein tips 70 are inserted into ground G (best shown in FIGS. 1 and 2). Thin film sheet 30 is disposed across the prevailing wind direction and provides protection from severe cold wind, but permits air flow into interior of frost guard 10 via C-shaped apertures 40, thereby allowing the air to be freshened to prevent mildew, mold and plant diseases caused by cold moist conditions. The shape of apertures 40 permits some flow of air when such is impacting on thin film sheet 30, but provides a closed surface when air is not so impacting. Moisture in the interior of frost guard 10 preferentially condenses on thin film 30, keeping moisture off of plants F, thereby preventing buildup of frost on plants F.

When conditions are such that protection is no longer required, frost guard 10 is easily removed, collapsed and/or reutilized when needed.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A frost guard comprising:
a thin sheet of flexible material; and
a plurality of U-shaped securing stakes.

2. The frost guard of claim 1, further comprising a plurality of ventilation apertures in said thin sheet of flexible material.

3. The frost guard of claim 1, wherein said thin sheet of flexible material is transparent.

4. The frost guard of claim 3, wherein said thin sheet of flexible material comprises a plastic sheet of approximately 3 mils thickness.

5. The frost guard of claim 1, wherein said plurality of U-shaped securing stakes each comprise a semicircular section and two straight sections, each of said two straight sections having a first end connected to said semicircular section, and wherein said two straight sections are approximately parallel.

6. The frost guard of claim 5, wherein said two straight sections each comprise a second end, and wherein said second ends comprise tapered points.

7. The frost guard of claim 6, wherein individual U-shaped securing stakes of said plurality of U-shaped securing stakes are spaced apart by approximately two and one half feet.

8. The frost guard of claim 7, wherein said thin sheet of flexible material comprises portions disposed in contact with said two straight sections and said semicircular section of each of said plurality of U-shaped securing stakes.

9. The frost guard of claim 8, wherein said portions of said thin sheet of flexible material disposed in contact with said two straight sections comprise a plurality of ventilation apertures.

10. The frost guard of claim 9, wherein said ventilation apertures are generally C-shaped.

11. The frost guard of claim 10, wherein said tapered points are installed in a ground surface.

12. The frost guard of claim 11, wherein said frost guard further comprises an envelope of approximately ten feet in length, three feet in height and two feet in width, and wherein said frost guard covers plants in said ground surface.

13. A method of protecting plants from frost, said method comprising the steps of:
obtaining a sheet of thin, flexible material and a plurality of U-shaped securing stakes comprising arms;
forming said thin, flexible material into a U-shape over said U-shaped stakes;
securing said thin, flexible material to said U-shaped stakes; and
pressing said arms of said U-shaped stakes into a ground surface, wherein said envelope covers plants disposed within said ground surface.

14. The method of claim 13, further comprising the step of:
providing apertures in said thin, flexible material, wherein air flows therethrough.

15. A frost prevention envelope comprising:
a sheet of transparent film disposed over a plurality of inverted U-shaped support stakes.

16. The frost prevention envelope of claim 15, wherein said U-shaped support stakes are inserted into a ground surface.

17. The frost prevention envelope of claim 16, wherein said frost prevention envelope is approximately ten feet in length, three feet in height and two feet in width.

18. The frost prevention envelope of claim 17, wherein said sheet of transparent film comprises apertures dimensioned to allow airflow therethrough, and wherein said apertures are generally C-shaped.

19. The frost prevention envelope of claim 18, wherein said U-shaped support stakes comprise a semicircular top section and two generally straight, parallel leg sections.

20. The frost prevention envelope of claim 19, wherein said sheet of transparent film is disposed between said U-shaped support stakes, and wherein a portion of said sheet of transparent film is disposed in contact with said two generally straight, parallel leg sections, and another portion is disposed in contact with said semicircular top section, and wherein said apertures are disposed in said portion.
